(19) United States
(12) Patent Application Publication
(10) Pub. No.: US 2004/0108986 A1
(43) Pub. Date: Jun. 10, 2004

(54) Chiral laser display apparatus and method

(76) Inventors: Victor Il?apos;ich Kopp, Flushing, NY (US); Azriel Zelig Genack, New York, NY (US)

Correspondence Address: Edward Etkin, Esq., Suite 3C, 4804 Bedford Avenue, Brooklyn, NY, 11235, US

(21) Appl. No.: 10/724,341

(22) Filed: Nov. 29, 2003

Related U.S. Application Data
(60) Provisional application No. 60/429,975, filed on Nov. 29, 2002.

(51) Int. Cl. G09G 3/36

(52) U.S. Cl. 345/87

(57) ABSTRACT

A thin chiral film display is provided in several embodiments. In one inventive embodiment, an array of chiral lasers is utilized in a passive or active matrix display configuration. In another embodiment of the present invention, at least one chiral laser is used as a highly efficient low cost backlight for a conventional passive or active matrix display or microdisplay.

### CROSS REFERENCE TO RELATED APPLICATIONS

The present patent application claims priority from the commonly assigned U.S. provisional patent application S/N 60/429,975 entitled “Chiral Laser Display Apparatus and Method” filed Nov. 29, 2002.

### FIELD OF THE INVENTION

The present invention relates generally to video displays, and more particularly to a video display utilizing chiral film lasers for imaging or backlighting.

### BACKGROUND OF THE INVENTION

Various types of video displays for computers and other applications have been in use for many years. In the past several years there has been a proliferation of flat panel displays of various sizes based on different technologies (such as active and passive matrix LCD, plasma, etc.). However, several challenges remain—the image quality (intensity, saturation, contrast), high cost, and power consumption for backlighting (which is particularly important for portable displays).

It would thus be desirable to provide a display apparatus and method that is simple to implement and manufacture, relatively inexpensive, light, small, reliable and with superior image quality and intensity. It would further be desirable to provide a display apparatus and method that provides high quality backlighting with low power consumption.

### BRIEF DESCRIPTION OF THE DRAWINGS

In the drawings, wherein like reference characters denote elements throughout the several views:

FIG. 1 is a schematic diagram of a first embodiment of a chiral laser display of the present invention wherein an array of chiral lasers are used as pixels; and

FIG. 2 is a schematic diagram of a second embodiment of a chiral laser display of the present invention wherein one or more chiral lasers are used to provide backlighting in a standard display.

### SUMMARY OF THE INVENTION

The present invention is directed to a novel video display utilizing chiral lasers to achieve vastly superior characteristics and operational parameters in most respects as compared to previously known display systems. Chiral lasers produce broad area lasing from a thin polymeric film at low pump power thus significantly reducing power consumption. Lasing can be set to any frequency throughout the visible to give true colors and wide area coherence will provide uniform light across each pixel of a display. The laser output is naturally polarized, providing additional efficiency. A chiral laser itself is a low cost device that can be made via web-based processing and is compatible with OLED processing currently being developed. Because chiral lasers may be built as polymeric film, they are lightweight and can thus be contoured and/or made flexible. Depending on configuration, chiral lasers may either be optically pumped via an optical pump or electronically pumped.

In a first embodiment of the inventive chiral laser display, an array of chiral lasers is used to construct an active or passive matrix display, eliminating the need for a backlight. In a second embodiment of the inventive chiral laser display, one or more chiral lasers is used to provide highly efficient low-power consumption uniform backlighting for a conventional LCD active or passive matrix display.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims.

### DETAILED DESCRIPTION OF PREFERRED EMBODIMENTS

Before describing the present invention in greater detail, it would be helpful to provide definitions of common terms utilized in the dielectric lasing art. “Chiral” materials are not symmetrical, that is they are not identical to their mirror images. Cholesteric materials, such as cholesteric liquid crystals (hereinafter “CLCs”), have multiple molecular layers where molecules in the different layers are oriented on average at a slight angle relative to molecules in other layers. Molecules in consecutive layers are rotated slightly relative to those in the preceding layer. Thus, the average direction of the molecules, known as a “director”, rotates helically throughout the cholesteric material. A pitch of a cholesteric material is defined as a thickness of the material in which the director rotates a full 360 degrees. Cholesteric structures also have a property called “handedness”—they may be right-handed or left-handed depending on the direction of rotation of the molecules from layer to layer. The handedness of a cholesteric structure influences the circular polarization and amplitude of light passing through the structure.

Small, inexpensive laser devices utilizing chiral materials are described in a commonly assigned co-pending U.S. patent application entitled “Stop Band Laser Apparatus and Method”, (Ser. No. 09/919,662), which discloses a novel band gap laser with increased output power and low lasing threshold with improved control over the spatial, spectral, and temporal lasing parameters. A commonly assigned U.S. Pat. No. 6,404,789 entitled “Chiral Laser Apparatus and Method” also discloses a variety of electrically and optically pumped advantageous chiral lasers based on cholesteric liquid crystal (CLC) structures.

The essence of the present invention is utilization of chiral lasers to construct a display with vastly superior characteristics and operational parameters in every respect as compared to previously known display systems. Chiral lasers produce broad area lasing from a thin polymeric film at low pump power and will thereby reduce power consumption. The lasing can be tuned throughout the visible to give true colors and wide area coherence will provide uniform light across a display. The laser output is naturally polarized, providing additional efficiencies. A chiral laser itself is a low cost device that can be made via web-based processing and is compatible with OLED processing now being developed. Because chiral lasers may be built as polymeric film, they are lightweight, and can be contoured and/or made flexible. Depending on configuration, chiral lasers may either be optically pumped via an optical pump or electronically pumped using the source of a video signal as a pump.

In summary, in a first embodiment of the inventive chiral laser display, an array of chiral lasers is used to construct an active or passive matrix display, eliminating the need for a backlight. In a second embodiment of the inventive chiral laser display, one or more chiral lasers is used to provide highly efficient low-power consumption uniform backlighting for a standard LCD active or passive matrix display. It should be noted that the description of the embodiments of the present invention makes reference to LCD panels (active or passive) only by way of example. Other forms of display panels can be readily utilized instead of LCDs as a matter of design choice without departing from the spirit of the invention.

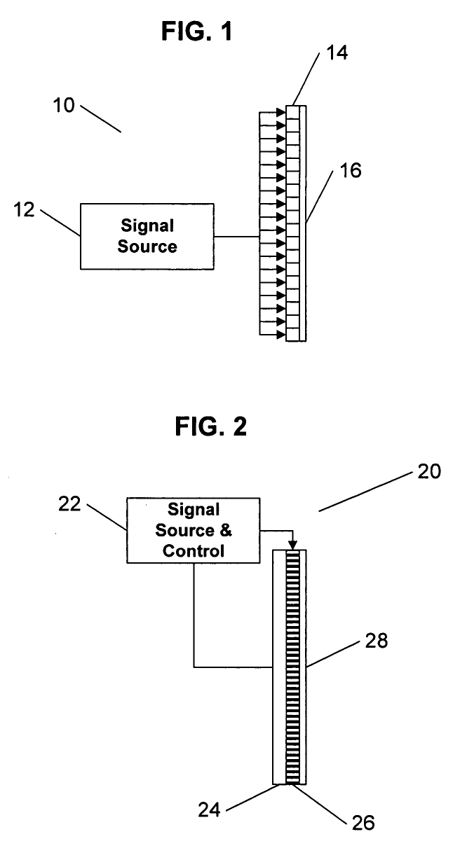

Referring now to FIG. 1, a first embodiment of the inventive chiral laser display is shown as a chiral display 10. The chiral display 10 includes a signal source 12 which serves as a source of the video signal being displayed. The signal source 12 is connected to a chiral laser array 14 consisting of a plurality of chiral lasers configured as proximal (i.e. side-by-side) or stacked pixel elements. The chiral laser array 14 may be configured in a passive or active matrix arrangement. The individual lasers in the chiral laser array 14 may be optically or electronically pumped as a matter of design choice.

A screen 16 is placed in front of the array 14. Optionally, the screen 16 can be configured as a focusing device if the chiral display 10 is configured as a microdisplay (or for example configured to project an image directly unto a user's retina). The chiral display 10 offers flexibility, low cost, ease of fabrication, as well as a very high quality image.

Referring now to FIG. 2, a second embodiment of the inventive chiral laser display is shown as chiral display 20. The chiral display 20 includes a signal source 22 which serves as a source of the video signal being displayed. The signal source 22 is connected to a display panel 26 (such as an LCD panel or microdisplay). A chiral laser backlight 24 is positioned behind the display panel 26 to provide high quality, efficient, uniform, and low-power backlighting. A screen 28 is placed in front of the display panel 26. The chiral backlight 24 provides wide-area lasing, and because it is a directional light source it is vastly superior to conventionally used electroluminescent backlights.

Furthermore, while the various embodiments of the present invention have been discussed with reference to CLC or thin film chiral lasers, it should be noted that other forms of chiral lasers can be advantageously configured to function in the various embodiments of the present invention as a matter of design choice. For example, a single chiral fiber laser, such as disclosed in the co-pending commonly assigned U.S. patent application entitled “Chiral Fiber Laser Apparatus and Method” (Ser. No. 10/299,651), or an array of chiral fiber lasers, may be readily adapted to serve as a red green or blue laser in each of FIGS. 1 to 3.

Thus, while there have been shown and described and pointed out fundamental novel features of the invention as applied to preferred embodiments thereof, it will be understood that various omissions and substitutions and changes in the form and details of the devices and methods illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. It is the intention, therefore, to be limited only as indicated by the scope of the claims appended hereto.

We claim:

1. A chiral laser apparatus for displaying a video image produced by a signal source connected thereto, comprising:
a plurality of chiral laser elements connected to the signal source and configured for displaying the video image received from the signal source, wherein each said plural chiral laser element displays a predetermined portion of said video image.

2. The chiral laser apparatus of claim 1, wherein said plural chiral laser elements are configured in one of a passive matrix and active matrix configurations.

3. A display apparatus for displaying a video image produced by a signal source connected thereto, comprising:
a flat display panel connected to the signal source and configured operable to display the video image received therefrom; and
at least one chiral laser element positioned behind said flat display panel operable to provide a wide area coherent backlight for said flat display panel.

4. The display apparatus of claim 3, wherein said flat display panel is a LCD panel.

5. A chiral display method for displaying a video image produced by a signal source, comprising the steps of:
a) providing a plurality of chiral laser elements connected to the signal source and configured for displaying the video image received from the signal source; and
b) causing each said plural chiral laser element to display a predetermined portion of said video image.

6. The chiral display method of claim 5, wherein said plural chiral laser elements are configured in one of a passive matrix and active matrix configurations.

7. A chiral display method for displaying a video image produced by a signal source, comprising the steps of:
a) providing a flat display panel connected to the signal source and operable to display the video image received therefrom; and
b) providing at least one chiral laser element positioned behind said flat display panel; and
c) causing said at least one chiral laser element to provide a wide area coherent backlight for said flat display panel.

8. The chiral display method of claim 7, wherein said flat display panel is a LCD panel.
